(19) United States
(12) Patent Application Publication
(10) Pub. No.: US 2007/0238333 A1
(43) Pub. Date: Oct. 11, 2007

(54) BATTERY PACK

(76) Inventors: Heiko Roehm, Stuttgart (DE); Daniel Hirt, Kirchentellinsfurt (DE)

Correspondence Address: STRIKER, STRIKER & STENBY, 103 EAST NECK ROAD, HUNTINGTON, NY, 11743, US

(21) Appl. No.: 11/687,887

(22) Filed: Mar. 19, 2007

(30) Foreign Application Priority Data
Apr. 7, 2006 (DE) 10 2006 018 011.9

(51) Int. Cl. H01R 13/44

(52) U.S. Cl. 439/131

(57) ABSTRACT

In a battery pack for an electrical device has a base body, including a mounting shell and a cover shell, and that has an electrical module, the electrical module is secured in the base body by cooperation of the mounting shell and the cover shell.

### CROSS-REFERENCE TO A RELATED APPLICATION

The invention described and claimed hereinbelow is also described in German Patent Application DE 102006018011.9 filed on Apr. 7, 2006. This German Patent Application, whose subject matter is incorporated here by reference, provides the basis for a claim of priority of invention under 35 U.S.C. 119(a)-(d).

### BACKGROUND OF THE INVENTION

The invention is related to a battery pack for an electrical device.

A battery pack for a hand power tool is known. For supplying current to the hand power tool, it has a set of battery cells. The battery pack is also provided with a locking unit, which serves to lock onto a hand power tool handle.

### SUMMARY OF THE INVENTION

A battery pack for an electrical device, has a base body, including a mounting shell and a cover shell, and an electrical module.

It is proposed that the electrical module be secured in the base body by means of cooperation of the mounting shell and the cover shell. As a result, when the battery pack is put together the effort and expense of assembly can be advantageously reduced. Especially advantageously, tool-free securing of the electrical module in the base body can be achieved, and the use of fastening means for securing the electrical module in the base body can be dispensed with.

The term “module” should be understood in this connection to mean in particular a component of the battery pack that is other than the base body and that can be installed in the base body when the battery pack is put together. The base body is preferably embodied as a battery pack housing. The electrical module preferably represents a fastening interface between at least one electrical unit of the battery pack and the base body. The electrical unit expediently serves to produce a supply of electricity to the electrical device. The electrical unit is embodied as a battery cell, for instance. The electrical unit may also be embodied as a contacting element, such as a metal contact latch or contact cup, which serves to make an electrical contact with a counterpart connection means of the electrical device. The electrical unit may also be an electrical cable connection, which preferably connects a battery cell and a contacting element. Expediently, the electrical module includes a fastening means for securing the electrical unit. Especially advantageously, the electrical module can be provided for tool-free fastening of the electrical unit, for instance by making a form lock.

To make economies of components and mounting steps attainable, the electrical module is advantageously embodied in one piece. The electrical module and the electrical unit preferably form a structural unit, which with the primary interest of putting the battery pack together can be preassembled separately from the base body and which, after its assembly can be built into the mounting shell as a cohesive unit. The electrical module can be secured in the base body by a form-locking connection with the mounting shell and the cover shell.

It is furthermore proposed that the electrical module is secured in the base body by a clamping connection with the mounting shell and the cover shell. As a result, an especially stable and in particular play-free fastening of the electrical module in the base body can be attained.

In an advantageous refinement of the invention, it is proposed that the base body has a fastening means for fastening or securing the cover shell to the mounting shell which forms a support region for bracing the electrical module. As a result, a construction-dictated region of the base body can advantageously be utilized to brace the electrical module, and an especially compact design of the battery pack can be achieved. In particular, the fastening means may be embodied as a screw receptacle.

It is further proposed that the battery pack has a receiving region for receiving the electrical module, which region is recessed out of the mounting shell and is intended for making a form lock with the electrical module. As a result, especially effective bracing of the electrical module on the mounting shell can be achieved. To that end, the recess preferably has a shape that adapts to the design of the electrical module, so that play-free bracing on the mounting shell can be achieved.

In a preferred embodiment, it is proposed that the base body has a partial region which is intended for receiving at least one electrical device connection means and forms a support region for bracing the electrical module. As a result, an especially compact embodiment of the base body can be achieved, and an existing region of the base body can be utilized to brace the electrical module. This partial region is preferably formed integrally on the cover shell.

It is further proposed that the electrical module includes a receiving region for receiving a battery cell, and the base body has a bracing means for bracing the battery cell, which means engages the receiving region. A compact embodiment of the battery pack and an advantageous bracing of the battery cell can be achieved by cooperation of the electrical module and the base body. The bracing means is preferably integrally molded onto the mounting shell.

In an advantageous embodiment, it is proposed that the battery pack has at least one battery cell and a raised area of the mounting shell, which is embodied as a bracing means for bracing the battery cell. As a result, great stability of the battery cell, or of a set of battery cells, inside the base body can be attained. The raised area preferably protrudes from a cohesive surface of the mounting shell. In particular, this cohesive surface can be embodied as a supporting face on which at least one battery cell can be placed. The raised area expediently has a shape that adapts to the design of the battery cell. As a result, play-free bracing of the battery cell on the raised area can be attained. If the battery pack has at least one second battery cell, then the shape of the raised area can additionally be adapted to an interstice between the battery cells. If the electrical module has a receiving region for receiving the battery cell, the raised area can form a continuation of the receiving region, making it possible to attain an especially stable bracing of the battery cell by cooperation of the base body and the electrical module.

In a preferred embodiment of the invention, it is proposed that the battery pack has a locking means for locking the base body to the electrical device, which means is secured to the electrical module. As a result, robust bracing of the locking means can be achieved, and the effort and expense of assembly can be reduced still further. To make it possible to economize on further assembly steps, the electrical module can be intended for tool-free fastening of the locking means. In particular, the electrical module may have a fastening means that is intended for making a form lock, such as a detent or snap connection, with the locking means.

An electrical device, in particular an electric tool with an electrical device base body, such as a handle, is furthermore proposed. It advantageously has a battery pack that is removable from the electrical device base body and that has both a base body, which includes a mounting shell and a cover shell, and an electrical module; the electrical module is secured in the base body by cooperation of the mounting shell and the cover shell. As a result, the effort and expense of assembly can advantageously be reduced. The electrical device can furthermore be embodied as a charger for recharging the battery pack.

Further advantages will become apparent from the ensuing description of the drawings. In the drawings, one exemplary embodiment of the invention is shown. The drawing, description and claims include numerous characteristics in combination. One skilled in the art will expediently consider the characteristics individually as well and put them together to make useful further combinations.

### BRIEF DESCRIPTION OF THE DRAWINGS

FIG. 1 shows a rechargeable-battery-operated power screwdriver with a handle and with a battery pack locked to the handle;

FIG. 2, a sectional view of the battery pack of FIG. 1, with a mounting shell, an electrical module, and a locking unit fastened to the electrical module;

FIG. 3, the electrical module and the locking unit in a perspective view;

FIG. 4, the battery pack in a sectional view from above;

FIG. 5, a supporting region for placement of the electrical module on it, in a detailed view;

FIG. 6, the mounting shell in the view of FIG. 4, with the electrical module removed;

FIG. 7, a section through a cover shell and the electrical module of the battery pack;

FIG. 8, the battery pack disposed in a charger; and

FIG. 9, the battery pack and the charger, in a sectional view from above.

### DESCRIPTION OF THE PREFERRED EMBODIMENTS

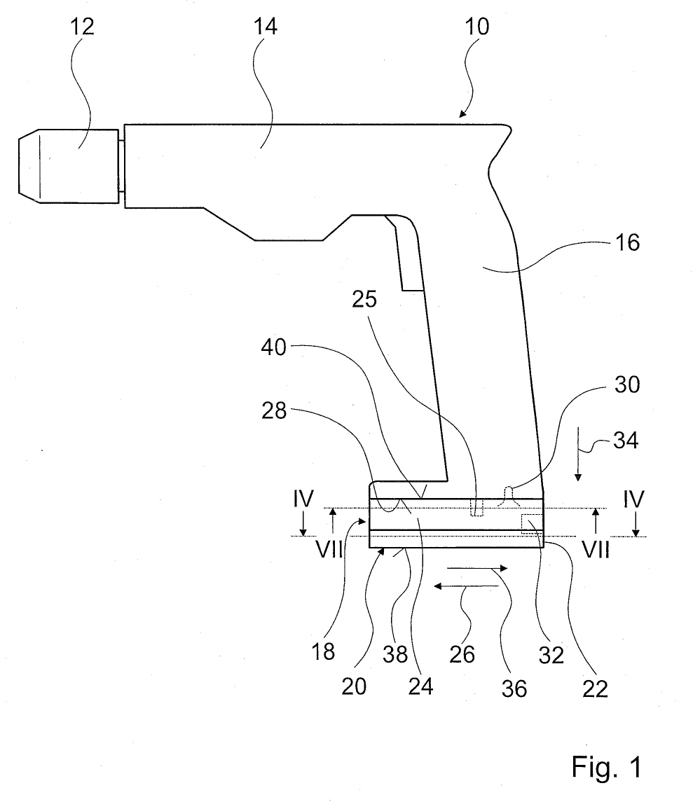

FIG. 1 shows an electrical device 10 embodied as a hand power tool. The hand power tool is embodied as a rechargeable-battery-operated power screwdriver. It has an electrical device base body 14, to which a tool receptacle 12 is secured. The electrical device base body 14 furthermore forms a handle 16, on which a battery pack 18 is located in locked fashion. The battery pack 18 includes a base body 20, which is embodied as a battery pack housing. This housing has a mounting shell 22, to which a cover shell 28 is secured. The electrical device 10 furthermore has electrical device connection means 25, by which an electrical connection with the battery pack 18 can be made. The battery pack 18 is embodied as a sliding battery pack.

For locking the battery pack 18 to the handle 16, the base body 20 is thrust in a sliding direction 26 along the handle 16, specifically along a lower outer face 28 of the handle 16 essentially perpendicular to the longitudinal direction of the handle 16. In the position shown in the drawing, the battery pack 18 is locked on the handle 18 by a locking means 30. In its locking position shown, this locking means is snapped into a detent recess, not shown in detail, of the handle 16. By actuation of an actuating means 32 (shown schematically in FIG. 1), the battery pack 18 can be unlocked from the electrical device 10, as a result of which the locking means 30 is moved in an unlocking direction 34.

After unlocking of the battery pack 18, the base body 20 can be disconnected from the electrical device 10, specifically by sliding the base body 20 in a removal direction 36 along the lower outer face 28 of the handle 16. The sliding direction 26 and the removal direction 36 are oriented substantially transversely to the longitudinal direction of the handle 16. The mounting shell 22 furthermore forms one base side 38 of the battery pack 18, while the cover shell 24 forms a coupling side 40, which in the locked state of the battery pack 18 rests on the handle 16. The base side 38 and the coupling side 40 are located diametrically opposite one another.

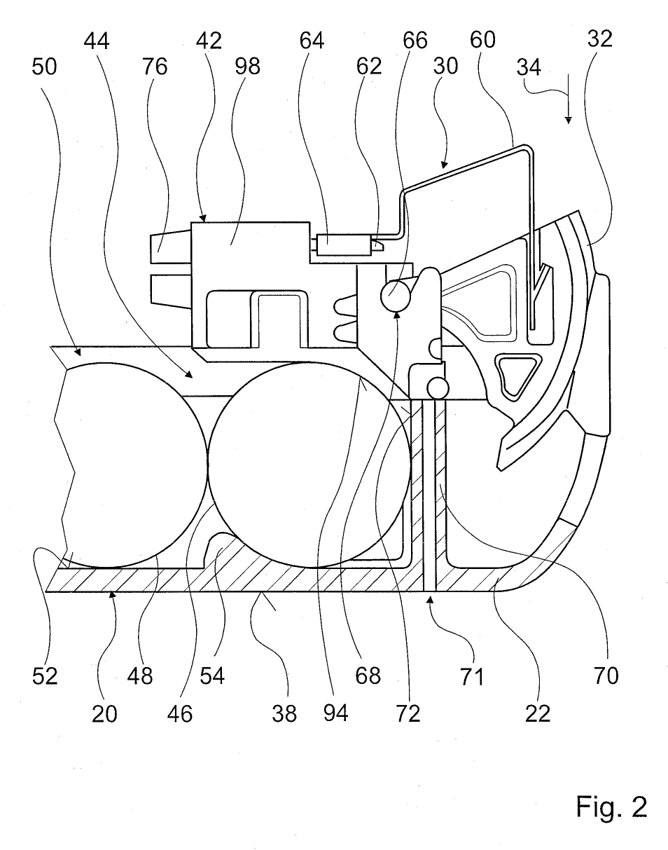

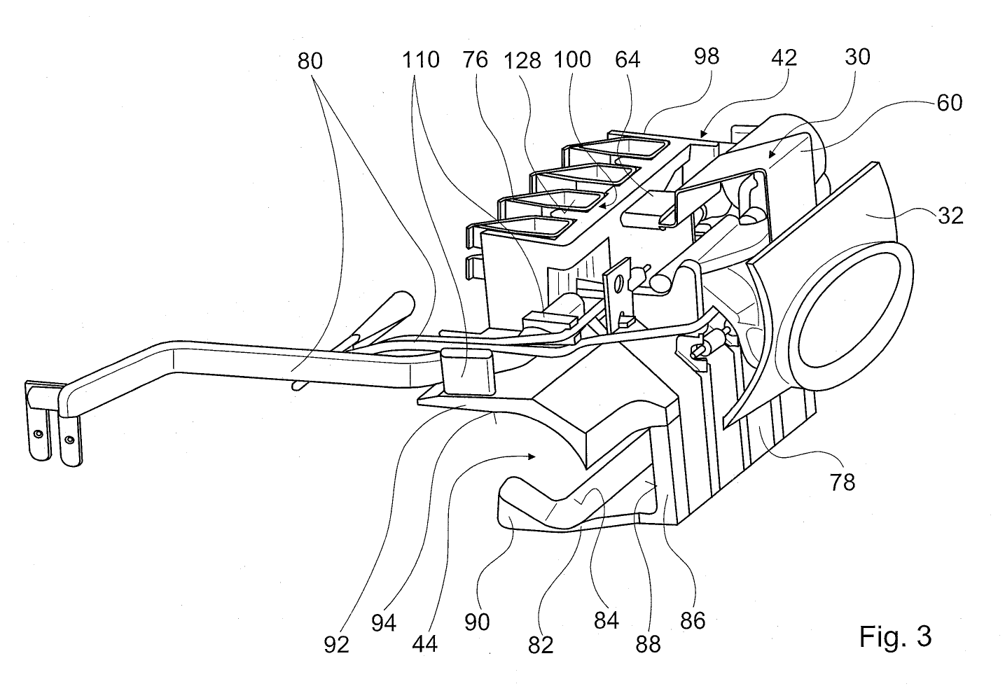

In FIG. 2, a sectional view of the battery pack 18 with the cover shell 24 removed can be seen. The mounting shell 22 can be seen, in which an electrical module 42 is mounted. The electrical module 42 is embodied as an integral component of the battery pack 18, which is distinguished from the base body 20 and which is inserted into the mounting shell 22 when the battery pack 18 is being put together. The electrical module 42 has a receiving region 44, in which a battery cell 46 is received. The receiving region 44 can also be seen in FIG. 3, and it has a shape that is adapted to the design of the battery cell 46. The electrical module 42 will be described in further detail in conjunction with FIG. 3.

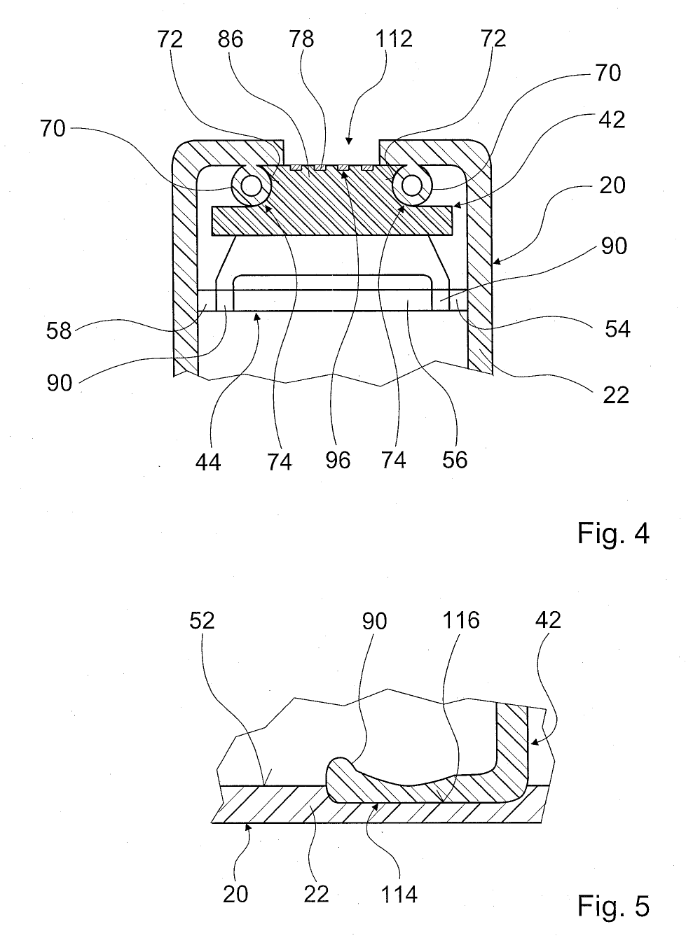

The battery cell 46, with further battery cells, of which one battery cell 48 can be seen in the drawing, forms a set 50 of battery cells that serve to supply current to the electrical device 10. The battery cell set 50 rests on a supporting face 52, which is formed by the mounting shell 22. A raised area is also integrally formed onto the mounting shell 22 and is embodied as a bracing means 54 for bracing the battery cells 46. This bracing means 54 protrudes from the supporting face 52 and is adapted to the design of the battery cell 46, so that play-free bracing of the battery cell 46 on the bracing means 54 is made possible. The mounting shell 22 is provided with further bracing means 56, 58, as can be seen from FIG. 4.

The locking means 30 can also be seen, which is embodied as a metal leaf spring that has a detent protrusion 60. In the locked state of the battery pack 18, shown in FIG. 1, the detent protrusion 60 is snapped into a detent recess in the handle 16. The locking means 30 is braced on one side on the electrical module 42. To that end, the electrical module 42 has a fastening means 62, embodied as a strut, around which one end 64 of the locking means 30 is locked in detent fashion. This makes tool-free fastening of the locking means 30 to the electrical module 42 possible. On the other side, the locking means 30 is secured to the actuating means 32, embodied in the form of a control button. To that end, the locking means 30 is snapped into the actuating means 32.

The actuating means 30 is also pivotably located on the electrical module 42. For that purpose, it has a pivot shaft 66. The electrical module 42 has a partial region, embodied as a pivot bearing 68, in which the pivot shaft 66 is located. Beginning in the locking position shown in FIG. 1, the base body 20 can be unlocked from the electrical device 10 by user operation of the actuating means 32 and a pivoting motion, tripped as a result, of the actuating means 32; in this process, the detent protrusion 60 is moved in the unlocking direction 34. Upon the motion of the detent protrusion 60, the end 64 remains firmly in its position on the electrical module 42, and as a result a deformation of the locking means 30 and a restoring force are engendered.

A fastening means 70 embodied as a screw receptacle is also integrally formed onto the mounting shell 22. The fastening means 70 extends perpendicular to the base side 38, and in its middle it forms an opening 71 that is intended for the passage of a screw through the mounting shell 22, for screwing the mounting shell 22 and the cover shell 24 together. On the other side of the electrical module 42, a further fastening means 70 is located (see FIG. 4). Each of the fastening means 70 forms a respective support region 72, on which the electrical module 42 is braced. In particular, the electrical module 42 is braced longitudinally of the mounting shell 42 parallel to the base side 38. The electrical module 42 has rounded portions 74 (see FIG. 4), which rest on the support regions 72 and are adapted to the outer contour of the fastening means 70, so that play-free bracing of the electrical module 42 on the fastening means 70 occurs.

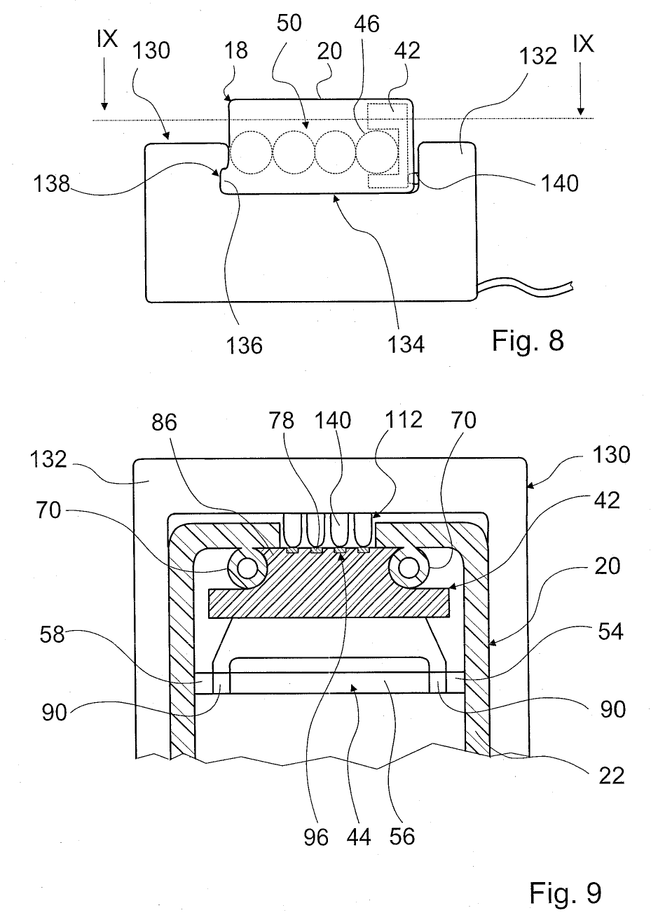

The electrical module 42 furthermore has electrical contacting elements 76, 78, which are intended for making an electrical contact with the electrical device 10, or with an electrical device 130 (see FIG. 8) embodied as a charger. One of the contacting elements 76 is shown in FIG. 2, while the contacting elements 78 can be seen in FIG. 3. For connecting the battery cell set 50 to the contacting elements 76, 78, the battery pack 18 is provided with cable connections 80, which are not shown in FIG. 2 for the sake of simplicity.

FIG. 3 shows the electrical module 42, the locking means 30, and the actuating means 32 in a perspective view. These components, together with the battery cell 46 or the battery cell set 50 and the cable connections 80, forms a structural unit, which can be preassembled separately from the base body 20 and after being assembled can be built as a cohesive unit into the base body 20. When this structural unit is assembled, the locking means 30, actuating means 32, battery cell set 50 with the battery cell 46, and the contacting elements 76, 78 are all secured to the electrical module 42. The cable connections 80 are then attached, which are soldered to contacts of the battery cell set 50 (not shown). This entire structural unit is then placed in the mounting shell 22. Next, the cover shell 24 is placed on the mounting shell 22, and the mounting shell 22 and the cover shell 24 are screwed to one another. For the sake of simplicity, the battery cell 46 is not shown.

The electrical module 42 has a base side 82, which in the assembled state rests on the mounting shell 22 (see also FIG. 5). The base side 82 also forms a contact face 84, on which the battery cell 46 rests in the assembled state. Oriented perpendicular to the base side 82, a wall element 86 can be seen, with a wall 88 on which the assembled battery cell 46 rests. A fastening means 90 for fastening the battery cell 46 is integrally formed onto the base side 82 and is embodied as a detent element, specifically as a pawl. Diametrically opposite the fastening means 90 is an identical fastening means 90, integrally molded onto the electrical module 42 (see FIG. 4).

When the battery cell 46 is placed in the receiving region 44, the battery cell 46, as a result of the fastening means 90, snaps into the receiving region 44. The wall element 86 is continued in the form of a roof element 92, which forms a further, partly curved, contact face 94, which is adapted to the embodiment of the battery cell 46 and on which the installed battery cell 46 rests (see also FIG. 2). The contact faces 84, 94, the wall 88, and the fastening means 90 define the receiving region 44. The wall element 86 furthermore forms receiving regions 96, designed as channels, in which the contacting elements 78, which are embodied as metal contact laminations, are received (see FIG. 4).

These contacting elements 78 serve to make an electrical contact with an electrical device 130, shown in FIG. 8 and embodied as a charger, for charging the battery cell set 50. A contact-holding means 98, rising perpendicularly from the roof element 92, can also be seen. It forms receiving regions 100, which serve to receive the metal contacting elements 76. Upon locking of the battery pack 18 to the electrical device 10, and specifically when the battery pack 18 is slid along the outer face 28, the electrical device connection means 25 engage the inside of the contacting elements 76. An electrical connection between the contacting elements 76, 78 and the battery cell set 50 is established by the electrical cable connections 80. These cable connections 80 are snapped into snap elements 110 that are integrally formed onto the roof element 92.

In FIG. 4, the mounting shell 22 and the electrical module 42 are seen from above in a sectional view taken along a line IV-IV (FIG. 1). The battery cell set 50 is not shown. The fastening means 70 can be seen, which each form one of the support regions 72 on which the electrical module 42 is braced. For that purpose, the electrical module 42 has the curved portions 74, which are adapted to the design of the fastening means 70. This creates a play-free connection of the electrical module 42 to the fastening means 70. As described in conjunction with FIG. 3, the wall element 86 forms the receiving regions 93, in which the electrical contacting elements 78 are located.

Upon coupling of the battery pack 18 to the electrical device 130 embodied as a charger, contacting elements 140 of the charger engage an opening 112 in the mounting shell 22 and enter into contact with the contacting elements 78 (see FIG. 9). The fastening means 90 for fastening the battery cell 46 to the electrical module 42 are also visible. The mounting shell 22 furthermore has the bracing means 54, 56, 58 (see also FIG. 2), which are embodied as raised areas. The bracing means 56 engages the receiving region 44 and thus serves to brace the battery cell 46 located in the receiving region 44. The bracing means 54, 56, 58 in cooperation with the fastening means 90 form a support region, which is uniform over the width of the mounting shell 22, for raising the battery cell 46.

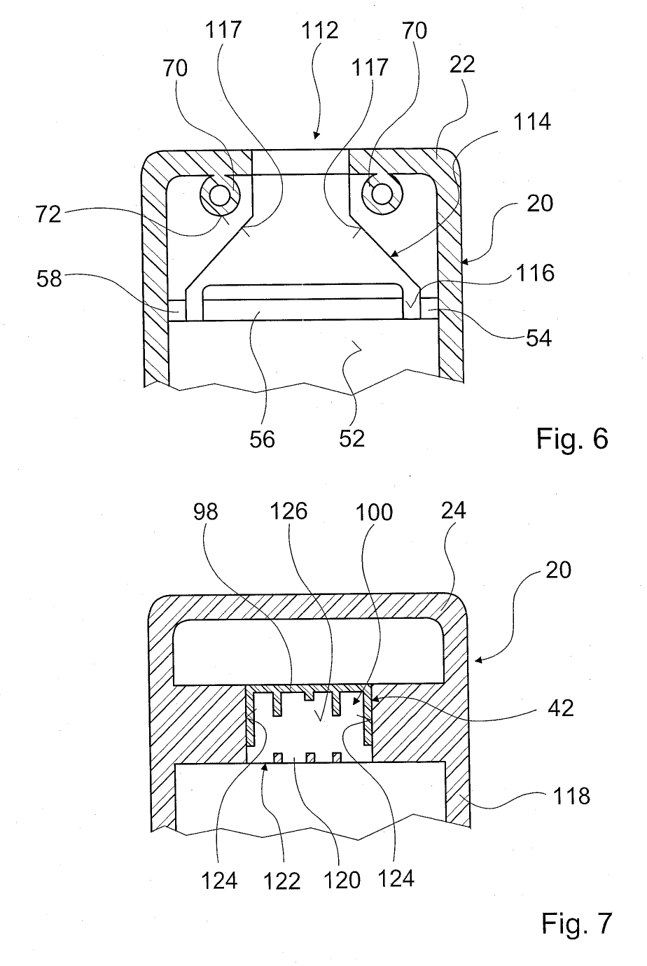

In FIG. 5, a support region of the electrical module 42 and of the mounting shell 22 is shown in a sectional view. One of the fastening means 90, embodied as a pawl, can be seen. For the sake of clarity, the battery cell 46 has not been shown. A receiving region 114 is recessed out of the mounting shell 22, and the electrical module 42 is received in this receiving region on being put together. The receiving region 114 forms a supporting face 116, which is offset relative to the supporting face 52. This receiving region 114 can also be seen in FIG. 6, in which the mounting shell 22 is shown in a view from above, with the electrical module 42 removed. The receiving region 114 has a shape that is adapted to the design of the electrical module 42. For that purpose, the shape of the receiving region 114 matches the embodiment of the base side 82 of the electrical module 42.

Walls 117 of this receiving region 114 that are created as a result of the offsetting of the supporting face 116 relative to the supporting face 52 brace the electrical module 42 without play as a result, both in the longitudinal direction of the mounting shell 22 and perpendicular to that longitudinal direction. By means of these walls 117 and the support regions 72 of the fastening means 70, the electrical module 42 is braced without play in the mounting shell 22 by means of a form lock.

In FIG. 7, a sectional view of the cover shell 24 taken along a line VII-VII is shown from below. A wall 118 of the cover shell 24 can be seen. A partial region 120 is integrally formed onto the cover shell 24 and forms openings 122, through which, when the battery pack 18 is being locked to the electrical device 10, the electrical connection means 25 for the electrical device reach to engage it and enter into contact with the contacting elements 76 of the battery pack 18. These contacting elements 76, not shown for the sake of simplicity, are located in the receiving regions 100 of the contact-holding means 98 (see FIG. 3).

The partial region 120 of the cover shell 24 forms support regions 124, on which the contact-holding means 98 rests. By these support regions 124, the electrical module 42 is braced without play, perpendicular to the longitudinal direction of the cover shell 24. The partial region 120 furthermore forms a further support region 126. In the installed state of the battery pack 18, an upper face 128 of the contact-holding means 98 (see FIG. 3) rests on the support region 126, creating a play-free bracing of the electrical module 42 perpendicular to the base side 38.

By cooperation of the support regions 124, 126 of the cover shell 24, the support regions 72, and the walls 117 of the mounting shell 22, a form-locking fastening of the electrical module 42 inside the base body 20 is created. The electrical module 42 is clamped in the base body 20 by the mounting shell 22 and the cover shell 24, as a result of which a play-free connection with the base body 20 is achieved, and also as a result of which, further fastening means for fastening the electrical module 42 to the base body 20 can be dispensed with.

In FIG. 8, the battery pack 18 is shown, located in an electrical device 130 embodied as a charger. The electrical device 130 has an electrical device base body 132, embodied as a housing. Internal components of the battery pack 18, and specifically the battery cell set 50 with the battery cell 46, and the electrical module 42 are shown schematically. The electrical device base body 132 forms a receiving region 134, in which the battery pack 18 is placed. A detent region 136 is integrally formed onto the base body 20 and is snapped into the detent recess 138 in the electrical device 130. For making an electrical contact with the battery pack 18, the electrical device 130 is provided with electrical contacting elements 140, which are embodied as resilient contact laminations. These contacting elements 140 rest on the contacting elements 78 of the battery pack 18 in a prestressed state (see also FIG. 5).

In FIG. 9, the arrangement of the electrical device 130 and of the battery pack 18 is shown in a sectional view from above. The base body 20 and the electrical module 42 can be seen. The battery cell set 50 is not shown, for the sake of simplicity. Upon coupling of the battery pack 18 to the electrical device 130 embodied as a charger, the contacting elements 140 engage the opening 112 in the mounting shell 22 and enter into contact with the contacting elements 78. In the process, the contacting elements 140 are pressed, so that they rest on the contacting elements 78 in the prestressed state.

It will be understood that each of the elements described above, or two or more together, may also find a useful application in other types of constructions differing from the type described above.

While the invention has been illustrated and described as embodied in a battery pack, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A battery pack for an electrical machine, comprising a base body including a mounting shell and a cover shell; an electrical module, said electrical module being secured in said base body by a cooperation of said mounting shell and said cover shell.

2. A battery pack as defined in claim 1, wherein said electrical module is secured in said base body by a clamping connection with said mounting shell and said cover shell.

3. A battery pack as defined in claim 1, wherein said base body has fastening means for fastening said cover shell to said mounting shell, which forms a support region for bracing said electrical module.

4. A battery pack as defined in claim 1; and further comprising a receiving region for receiving said electrical module, said receiving region being recessed out of said mounting shell and providing a form lock with said electrical module.

5. A battery pack as defined in claim 1, wherein said base body has a partial region for receiving at least one electrical device connection means and forms a support region for bracing said electrical module.

6. A battery pack as defined in claim 1, wherein said electrical module includes a receiving region for receiving a battery cell, said body having bracing means for bracing said battery cell and engaging said receiving region.

7. A battery pack as defined in claim 1; and further comprising at least one battery cell and a raised area of said mounting shell which is configured as bracing means for bracing said battery cell.

8. A battery pack as defined in claim 1; and further comprising locking means for locking said base body to the electrical device and being secured to said electrical module.

9. An electrical device, comprising an electrical base body; and a battery pack which is removable from said electrical device base body, said battery pack including a base body having a mounting shell and a cover shell, an electrical module, said electrical module being secured in said base body by a cooperation of said mounting shell and said cover shell.
